(19) United States
(12) Patent Application Publication
(10) Pub. No.: US 2004/0050869 A1
(43) Pub. Date: Mar. 18, 2004

(54) Delivery device

(76) Inventors: Douglas Jennings, Royston (GB); Bruce MacMichael, Ickleford (GB); Michael Paton, Royston (GB)

Correspondence Address: FISH & RICHARDSON PC, 225 FRANKLIN ST, BOSTON, MA, 02110, US

(21) Appl. No.: 10/450,971

(22) PCT Filed: Dec. 18, 2001
(86) PCT No.: PCT/SE01/02817

(30) Foreign Application Priority Data
Dec. 19, 2000 (SE) 0004751-4

(51) Int. Cl. B67D 5/06

(52) U.S. Cl. 222/183

(57) ABSTRACT

The present invention relates to a manually actuated delivery device for the delivery of a volume of liquid. The delivery device comprises a housing (1a, 1b, 1c) which includes an outlet (4) through which liquid, in use, is delivered, a removable cover member which at least partly covers the outlet (4), an actuating member (3) and a liquid delivery assembly (5, 6).

The present invention relates to a manually actuated delivery device for the delivery of a volume of liquid, In particular, a liquid containing medicament

WO-92/20455 discloses one example of such a delivery device which takes the form or a nasal Inhaler for the delivery of a volume of liquid containing medicament as a spray into a nasal cavity. This delivery device includes a nosepiece in the form of an elongate tubular section for insertion into a nasal cavity. The distal end nosepiece delivers the spray and is configured to be manually actuated by the application of a force axially relative to the longitudinal axis of the nosepiece.

Whilst such a delivery device is capable of delivering a metered volume of liquid, the use of the delivery device for delivery of a nasal spray can prove troublesome since the axial application of force tends to cause axial movement of the nosepiece within the nasal cavity which can lead to inefficient delivery of the liquid.

The present invention aims to overcome the problem of axial movement of the nosepiece by providing a delivery device configured such that the force for manual actuation Is applied substantially orthogonally to the axis of delivery of the liquid. With such a configuration, in advertent withdrawal or movement of the nosepiece can be obviated.

According to the present invention there is provided a manually actuatable delivery device for the delivery of a volume of liquid comprising a housing which includes an outlet through which liquid, in use, is delivered, an actuating member and a liquid delivery assembly, characterised in that the actuating member comprises a plurality of hinged elements forming a lifting frame which acts on the liquid delivery assembly.

Preferably, the hinged elements lift the liquid delivery assembly in a snap-action movement

Preferably, a removable cover member which at least partly covers the outlet wherein the cover member and actuating member cooperate when the cover member is in position covering the outlet to prevent the actuating member from initiating liquid delivery until the cover member is removed.

Preferably, the liquid delivery assembly comprises a liquid delivery unit and a carrier unit for the liquid delivery unit, which are slidable as a single unit within the housing.

Preferably, the hinged elements form at least one pivot point which bears against the carrier unit to lift it upwardly when force is applied to the actuating member by a user.

Preferably, the liquid-delivery unit comprises a container for liquid and a pump with a tubular nozzle, the tubular nozzle being slidable into the container to deliver a volume of liquid as a result of cooperation with a tubular feed within the housing when the carrier unit is lifted upwardly, the tubular feed leading to the outlet from the housing.

A preferred embodiment of the present invention will now be described in detail, by way of example only, with reference to the accompanying drawings, of which:

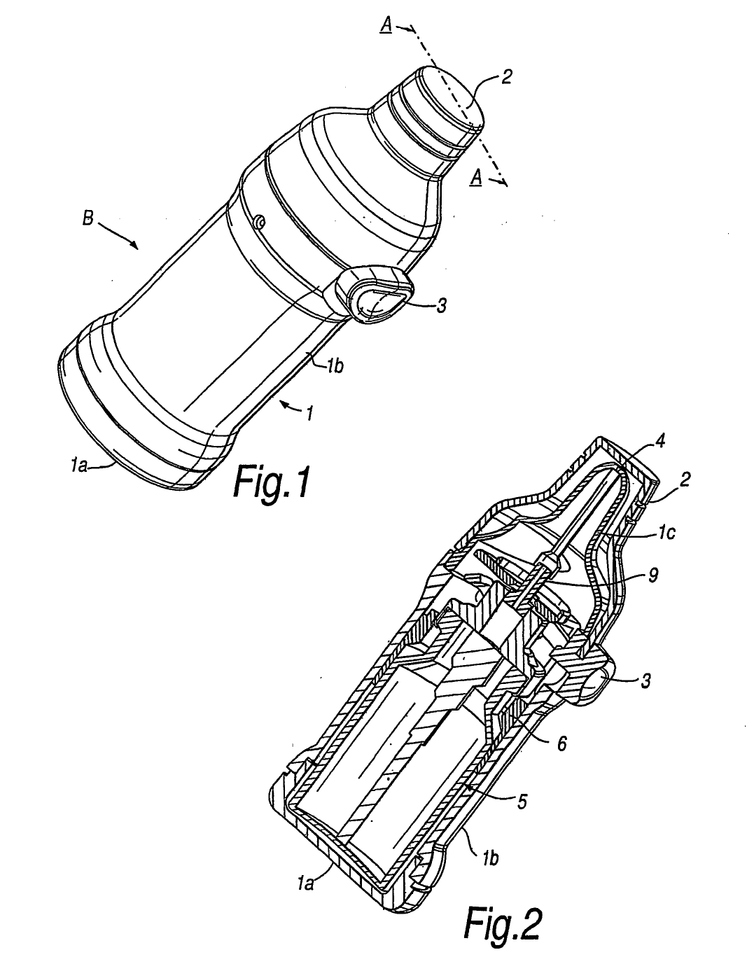

FIG. 1 is a perspective view of the delivery device with the cover member in position;

FIG. 2 is a section through the delivery device in FIG. 1 in direction A-A;

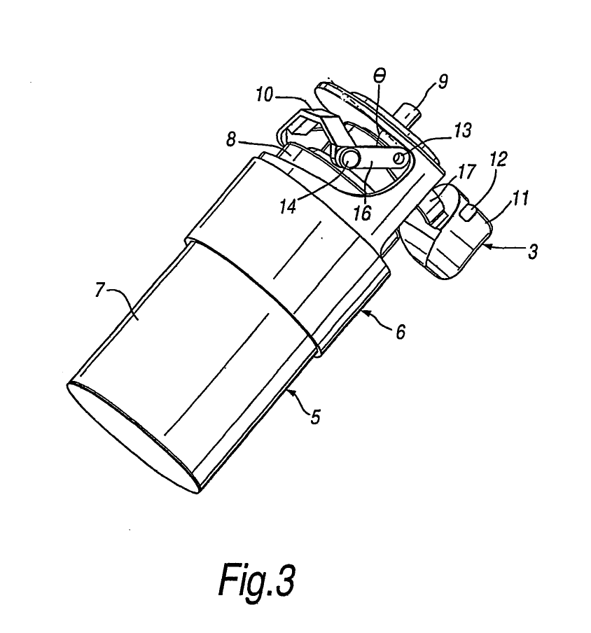

FIG. 3 is a perspective view of the internal features of the delivery device in FIG. 1 with the device rotated anticlockwise by 90°.

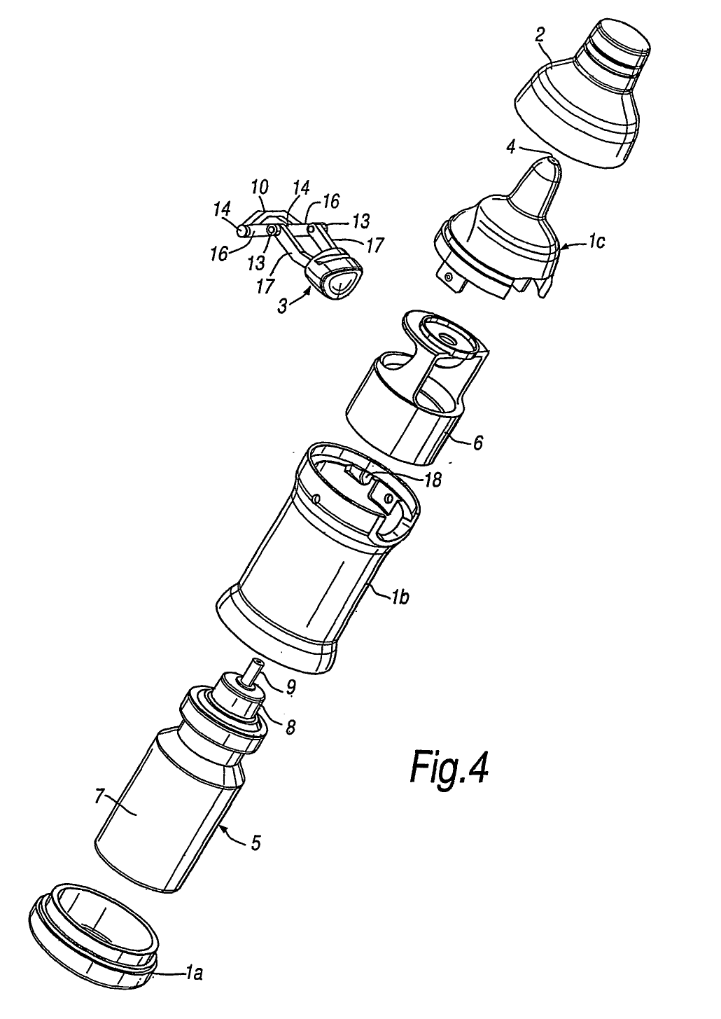

FIG. 4 is an exploded view in perspective of all the features of the delivery device;

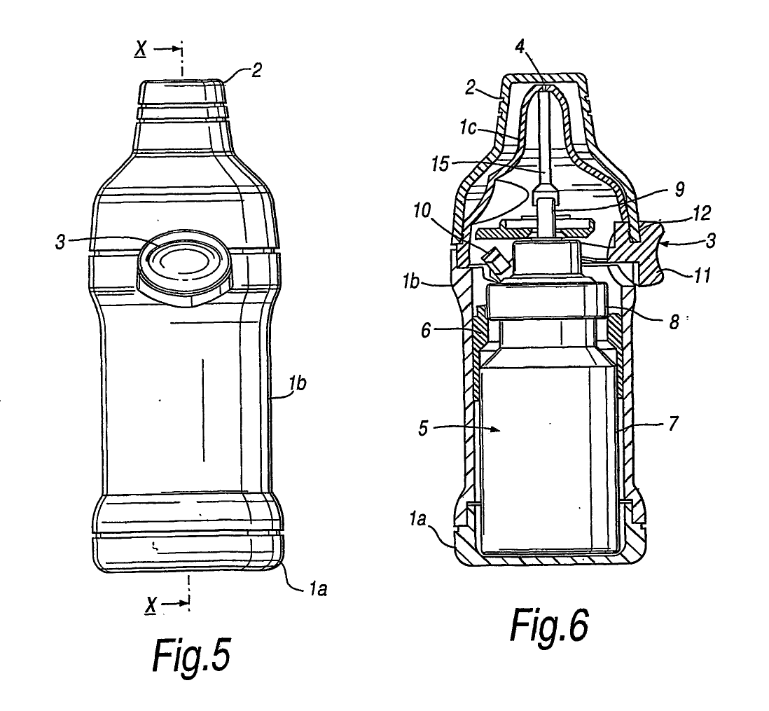

FIG. 5 is a view from the right hand side of the delivery device in FIG. 1;

FIG. 6 is a sectional view in direction X-X of the delivery device in FIG. 5;

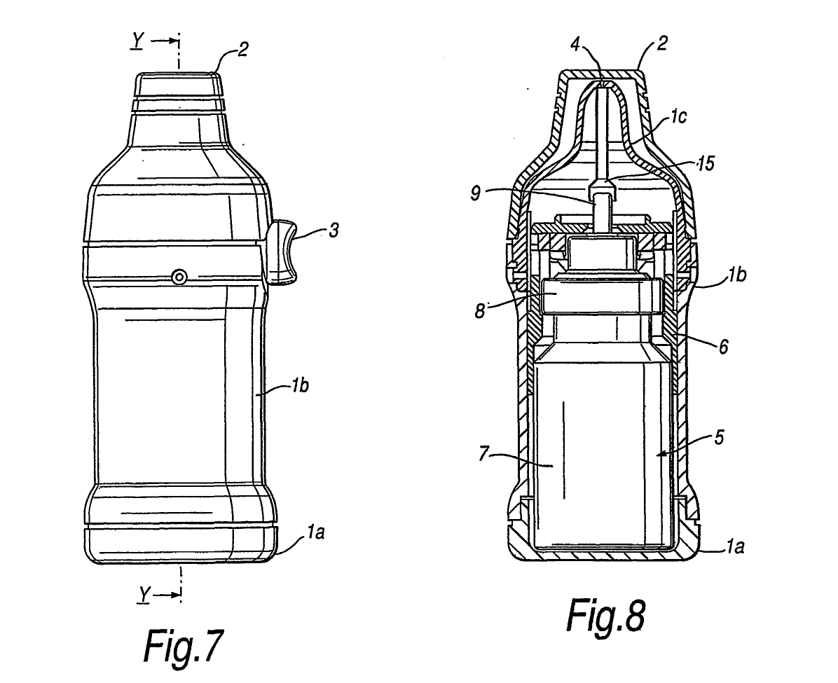

FIG. 7 is a view in direction B of the delivery device in FIG. 1; and,

FIG. 8 is a sectional view-in direction Y-Y of the delivery device in FIG. 7.

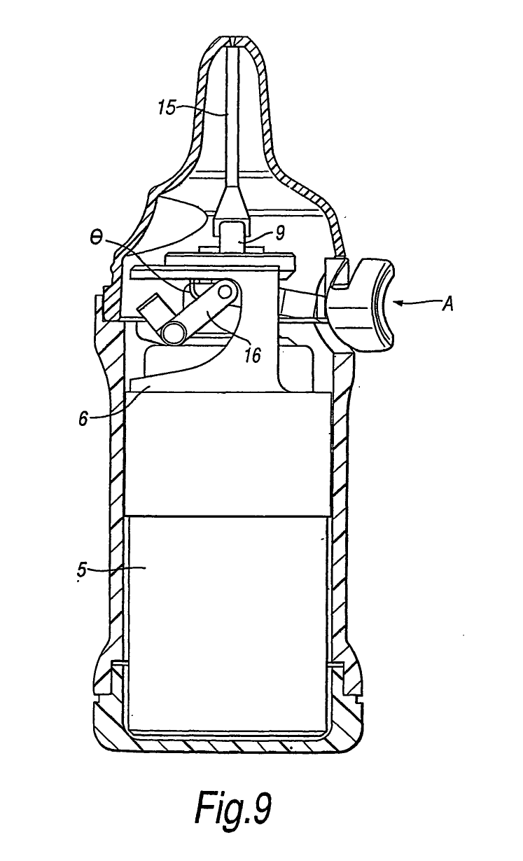

FIG. 9 is a partial sectional view in direction X-X In FIG. 5 with the carrier unit, delivery unit and actuating member non-sectdoned;

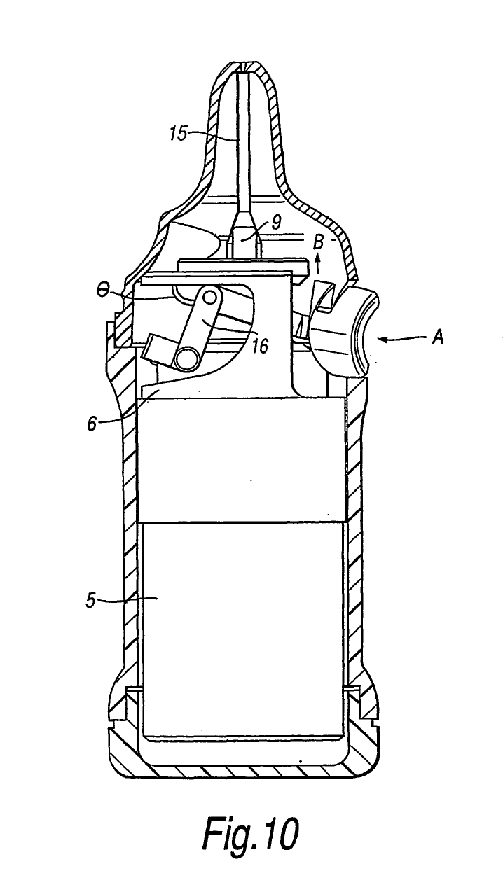

FIG. 10 corresponds to FIG. 9 depicting the delivery device in the actuating position.

The delivery device in FIG. 1 comprises a housing 1, which includes a base portion 1a, a body portion 1b and a nozzle portion 1c, a cover member 2 and an actuating member 3. The cover member 2 is removed simply by a gripping and pulling movement

In FIG. 2, the internal elements of the delivery device are shown. The cover member 2 is in position over the nozzle portion 1c of the housing 1. The nozzle portion 1c has an outlet 4 through which liquid is delivered. The delivery device also includes a liquid delivery assembly which comprises a liquid delivery unit 5 and a carrier unit 6.

The liquid delivery unit 5 is a typical liquid delivery pump comprising a container 7 for liquid and a pump 8 with a tubular nozzle 9. The tubular nozzle 9 is slidable into the container 7 against the action of an internal return spring (not shown) to deliver a volume of liquid.

The base portion 1a is a snap-fit into one end of the body portion 1b and the nozzle portion 1c is similarly a snap-fit into the other end of the body portion 1b. The housing parts can also be secured by a plastics weld achieved, for example, by ultrasonic welding.

FIG. 3 depicts the internal elements of the delivery device, in particular, the liquid delivery assembly 5,6 and the actuating member 3. In this Figure the construction of the actuating member 3 is clearly visible as a plurality of hinged elements 10, 16, 17 connected to an actuating button 11.

FIG. 4 is an exploded view of all the elements of the delivery device, whereas FIGS. 5 to 8 depict various views and sections through the delivery device with the cover member 2 in position. The cover member 2 cooperates with the actuating member 3 When in position over the outlet 4. This is clear from FIG. 6 where the open end of the cover member 2 sits in a slot 12 in the actuating button 11. In this way, the delivery device will not inadvertently actuate, for example, if dropped, unless the cover member 2 is removed.

FIGS. 9 and 10 depict the delivery device when the cover member 2 has been removed.

In use, the actuating button 11 is pressed by the user in the direction A which is substantially orthogonal to the axis of liquid delivery. When pressed, the actuating button 11 moves inwardly and the hinged elements 10, 16, 17 pivot at the pivot points 13,14 on each side of the actuating button 11. The pivot points 14 sit in sockets 18 on either side of the body portion 1b (see FIG. 4). The pivot points 13 bear against the carrier unit 6 which will rise in direction B and fall as the actuating button 11 is pressed and then released after actuation. Since the carrier unit 6 and liquid delivery unit 5 slide together, the actuating button 11 will cause the liquid delivery unit 5 to rise. In the actuating position (see FIG. 10) the tubular nozzle 9 cooperates with the tubular feed 15 which is located in the nozzle portion 1c.

The tubular feed 15 leads to the outlet 4. Therefore, when the tubular nozzle. 9 is pushed into the container 7 as the upward movement of the carrier unit 6 progresses, a volume of liquid will be delivered.

Because of the geometry of the hinged elements 10, 16 and 17 the actuating button 11 initially meets with a high resistance when the angle θ of link 16 (see FIGS. 3 and 9) is smaller. As the actuation progresses, the resistance decreases as angle θ of link 16 increases (see FIG. 10). At this point, the force on the tubular nozzle 9 is relatively much greater than the force applied by the user to the actuating button 11. The effect of this is that the user feels a decreasing resistance to further pressing and the actuating button “snaps” into the actuating position. The snap-action has the advantage that there is a reduced likelihood of a partial dose being delivered.

1. A manually actuatable delivery device for the delivery of a volume of liquid comprising a housing which includes an outlet through which liquid, in use, is delivered, an actuating member and a liquid delivery assembly, characterised in that the actuating member comprises a plurality of hinged elements forming a lifting frame which acts on the liquid delivery assembly.

2. A device as claimed in claim 1, Wherein the hinged elements lift the liquid delivery assembly in a snap-action movement.

3. A device as claimed in claim 1 or claim 2, wherein the device also comprises a removable cover member which at least party covers the outlet wherein the cover member and actuating member cooperate when the cover member is in position covering the outlet to prevent the actuating member from initiating liquid delivery until the cover member is removed.

4. A device as claimed in any preceding claim, wherein the liquid delivery assembly comprises a liquid delivery unit and a carrier unit for the liquid delivery unit, which are slidable as a single unit within the housing.

5. A device as claimed in claim 4, wherein the hinged elements form at least one pivot point which bears against the carrier unit to lift it upwardly when force is applied to the actuating member by a user.

6. A device as claimed in claim 5, wherein the liquid delivery unit comprises a container for liquid and a pump with a tubular nozzle, the tubular nozzle being slidable into the container to deliver a volume of liquid as a result of cooperation with a tubular feed within the housing. when the carrier unit is lifted upwardly, the tubular feed leading to the outlet from the housing.

7. A manually actuated delivery device substantially as herein described with reference to the accompanying drawings.
